(19) United States
(12) Patent Application Publication
(10) Pub. No.: US 2007/0152467 A1
(43) Pub. Date: Jul. 5, 2007

(54) Motor vehicle with movable roof part

(76) Inventors: Udo Heselhaus, Ibbenburen (DE); Winfried Bunsmann, Bissendorf (DE); Olaf Weissuller, Bramsche (DE)

Correspondence Address: QUINN LAW GROUP, PLLC, 39555 ORCHARD HILL PLACE, SUITE # 520, NOVI, MI, 48375, US

(21) Appl. No.: 10/597,100

(22) PCT Filed: Feb. 7, 2005
(86) PCT No.: PCT/DE05/00193

§ 371 Date: Aug. 23, 2006

(30) Foreign Application Priority Data
Feb. 7, 2004 (DE) 10 2004 006 137.8

(51) Int. Cl. B60J 7/00

(52) U.S. Cl. 296/107.01

(57) ABSTRACT

A motor vehicle has at least one movable roof part which extends in the closed position between lateral frame parts positioned above side windows and can be displaced from this position into an open position held inside the auto body. In the open position, the frame can be disassembled, and the frame parts may be separable from each other or hinged together.

### CROSS-REFERENCE TO RELATED APPLICATION(S)

This application is a US National Phase of International Application No. PCT/DE 2005/000193, filed Feb. 7, 2005, which claims priority to German 10 2004 006 137.8, filed Feb. 7, 2004. The entire contents of the above identified applications are incorporated herein by reference.

### TECHNICAL FIELD

The invention relates to a motor vehicle with at least one movable roof part and removable side frames according to the preamble of Claim 1 or Claim 2.

In vehicles with movable roof parts, it is known to arrange them guided between rigid lateral frame parts above side windows. It is also known in such vehicles to be able to remove the lateral frame parts after complete stowage of the roof parts in the body to improve an outdoors sensation. When they span the entire interior space from the windshield frame, however, they have a considerable longitudinal extent, so that difficult handling is the result and the removable frame parts require significant space. They must therefore be stored in a secure location, especially a garage. For many users of such vehicles this restricts the possibility of removing the frame parts, so that they dispense with this improvement of the outdoors feeling and drive with the lateral frame parts installed.

The underlying problem solved by the invention is to achieve an improvement here.

### SUMMARY OF THE INVENTION

The invention solves this problem by a vehicle with the features of Claim 1 or Claim 2. The additional Claims 3 to 8 are referred to with respect to advantageous embodiments of the invention.

According to the invention, both in the variant according to Claim 1 and the variant according to Claim 2, the greatest longitudinal extent of the disassembled frame parts can be reduced so that their storage is simplified, and is possible in spaces with smaller maximum extent.

It is particularly advantageous that the longitudinal extent of each of the sections is smaller than the vehicle width so that it becomes possible to carry the sections along in the vehicle during driving. This applies both for the frame parts with sections fully separable from each other and for frame parts with sections that are hinged to each other.

Handling is further simplified, in particular, if the sections of the frame parts can be secured to each other by a quick closure. Assembly and disassembly of the frame parts are therefore accelerated; the hazard of incorrect operations is reduced.

A limited weight also contributes to improvement of the handling characteristics of the lateral frame parts, which can be achieved by using lightweight materials, especially a metal foam material, for the frame parts.

When the removable frame parts are located before the lateral rear frames in the travel direction, between which a rear window is accommodated, they need not extend over the entire length of the interior space. Because of this the frame parts per vehicle side have sufficient length such that the sections come out smaller than the width of the trunk.

Additional advantages and features of the invention are apparent from a practical example of the object of the invention shown at least schematically in the drawings and described below.

### BRIEF DESCRIPTION OF THE DRAWINGS

In the drawings:

FIG. 1 shows a vehicle according to the invention in perspective view oblique from the rear with the closed roof parts,

FIG. 2 shows a similar view to FIG. 1 with an opened trunk and the front roof parts stowed in the auto body,

FIG. 3 shows a similar view to FIG. 1 with completely open roof parts but with lateral frame parts still not removed,

FIG. 4 shows a similar view to FIG. 3 after disassembly of the lateral frame parts,

FIG. 5 shows a disassembled lateral frame part in a top view,

FIG. 6 shows the frame part according to FIG. 5 in the pivoted-in state of its sections.

### DESCRIPTION OF THE PREFERRED EMBODIMENTS

In the drawing figures a four- or five-seat motor vehicle 1 generally equipped with a rear seat is shown. This is not essential. A two-seater can also be designed according to the invention.

Vehicle 1 comprises, at least above side windows 2, rigid frame parts 3 that each serve as roof supports and can be removed, which viewed from above lie essentially along the vehicle extent between a windshield frame 4 and the rear area 5 of the vehicle and in a side view are arc-shaped. At least one part of the frame parts 3 can also run above areas of auto body 9 not provided with side windows 2.

In the practical example rear frames 6 are adjacent to the frame parts 3 against the travel direction F, between which a rear window 7 is movably held. The rear frames 6 are a fixed component of the auto body here. This arrangement, however, is in no way essential. The removable frame parts 3 could instead also extend downward to a window parapet line 8 of the auto body 9.

In the depicted practical example, rear window 7 is a component of rear hatch 10 arranged between rear frames 6. It is designed essentially U-shaped here with a lower cross-arm 11, which can include parts of the tail lights and/or license plate holder and with side arms 12 that point forward and upward in the closed position of rear hatch 10 in the travel direction F according to the trend of the rear frame 6. Between parts 11 and 12 a rear window 7 is accommodated when it is in the closed position. The upper and, in the travel direction F, front edge 13 of the rear window 7 then simultaneously also forms the upper and front edge of the rear hatch 10 and is not held from below by a cross-arm because of its U shape.

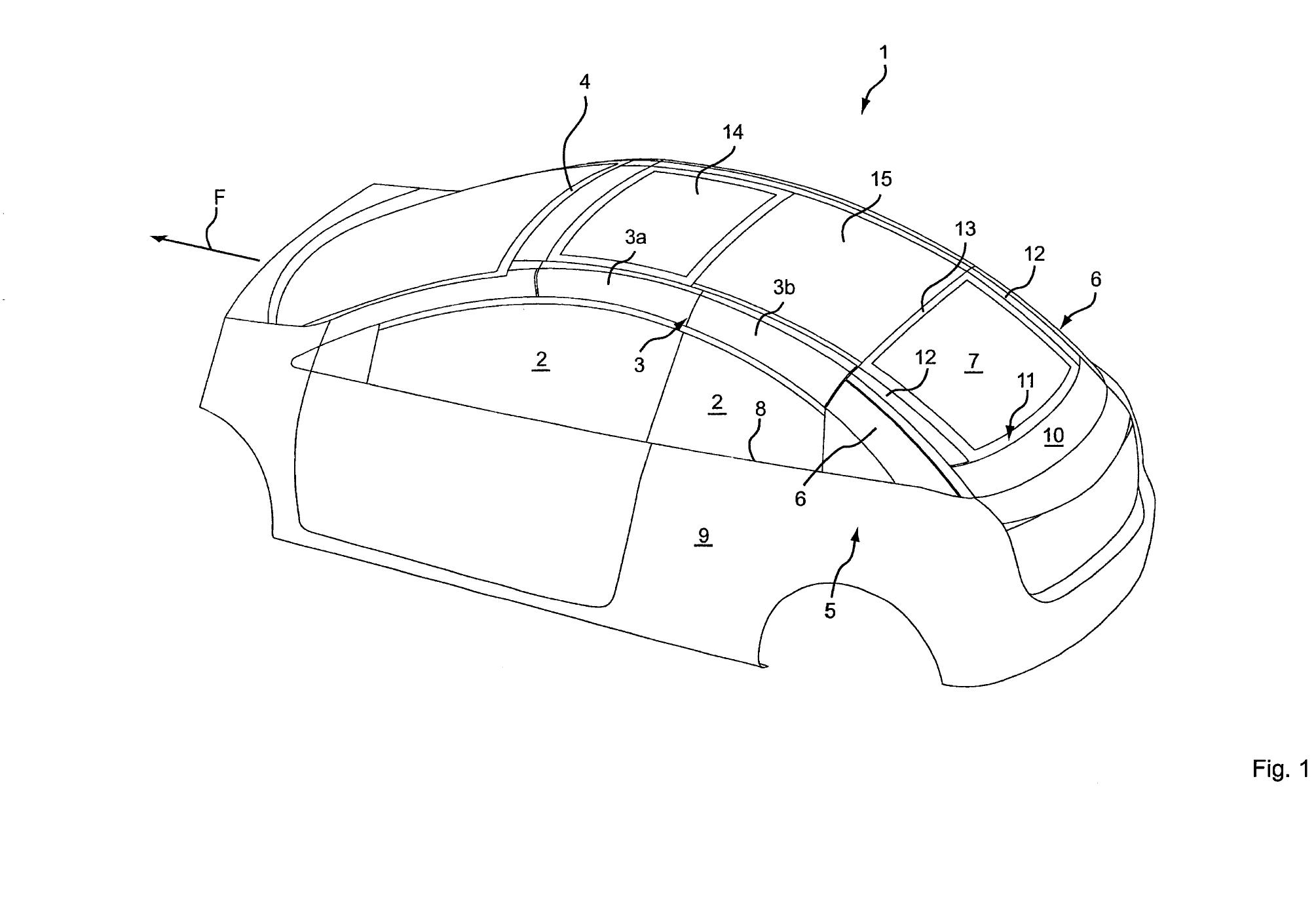

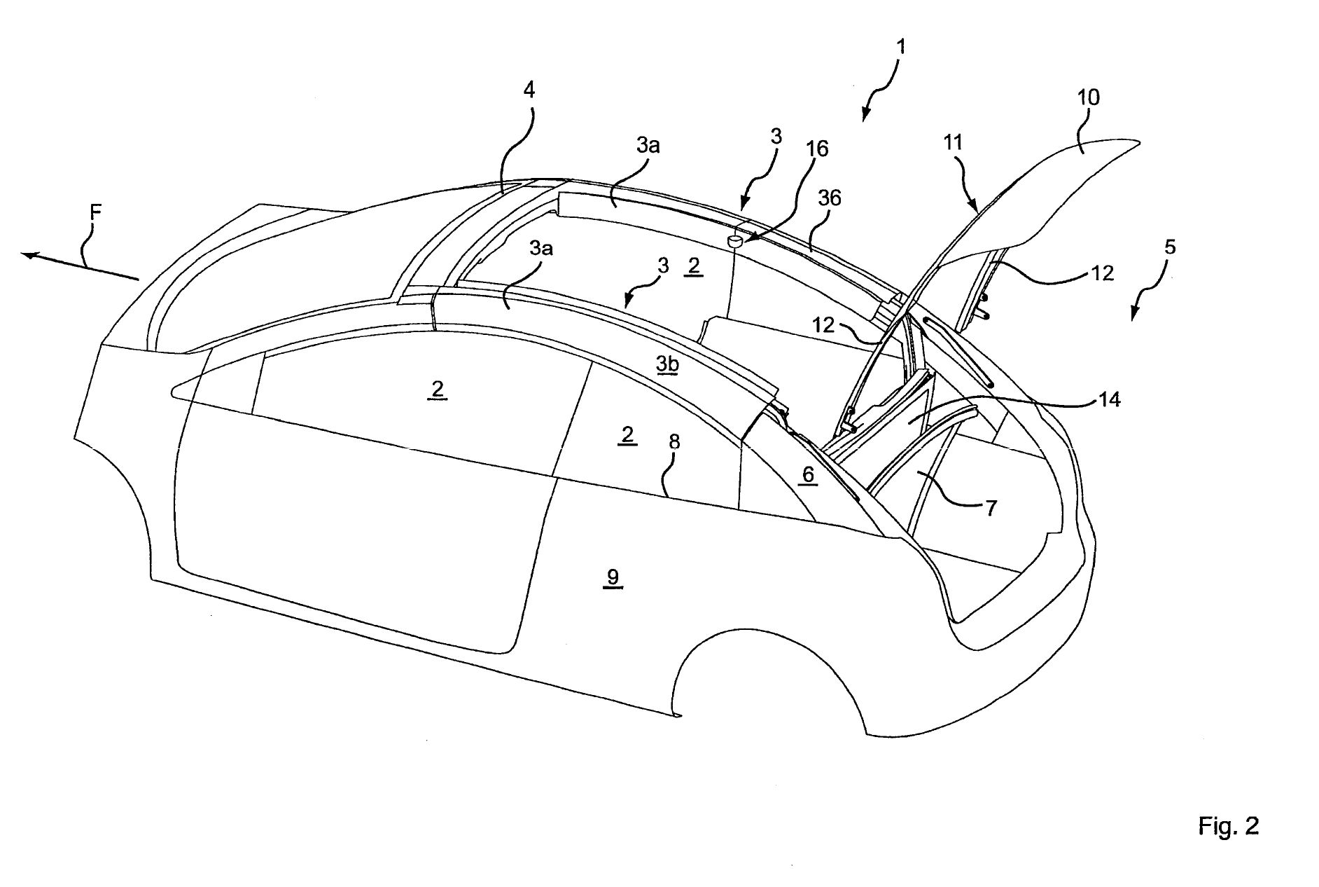

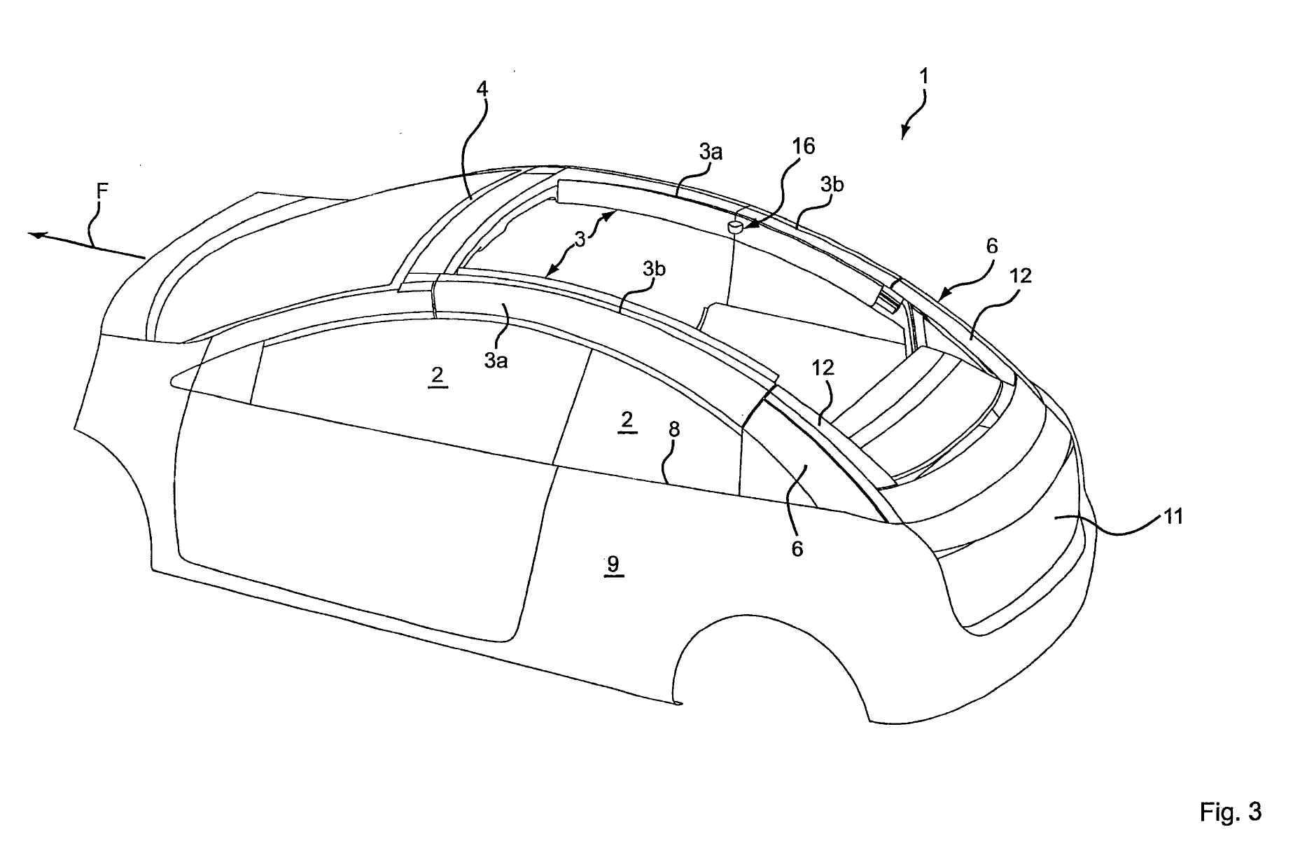

The rear hatch 10 is held between a closed (FIG. 1) and an open position (FIG. 2) movable on auto body 9. From the open position depicted in FIG. 2 of the rear hatch 10, the rear window 7 can be separately lowered head first into a release position into the vehicle body 9. After lowering, the rear hatch 10 can be closed again.

The vehicle 1 in the closed position of rear window 7 (FIG. 1) can also include adjacent to its front edge 13 additional roof parts arranged forward in travel direction F, here movable plate parts 14, 15. Their number is variable depending on the length of the roof. The roof parts 14 and 15 (two here) can also be formed from different materials, for example metallic, glass or plastic materials. In particular, they can be designed essentially transparent.

The front roof part 14 can be displaced from the closed position in the fashion of a sliding roof over the roof part 15 lying behind it and in its open position lies essentially parallel on top of it. The position of the roof parts 14, 15 so formed represents a possible permanent driving position. However, additional roof opening with downward displacement of the roof parts 14 and 15 lying one above the other as a stack can also occur in order to lower them into auto body 9. In this position they can stand almost vertically, just like the lower rear window 7 in space-saving fashion, for example, behind the backs of the second row or seats.

When the front roof part 14 is directly connected to the windshield frame 4, a very large roof opening can be produced. The lateral frame parts 3 can also be designed very narrow above the side windows so that the width of the plate parts 14, 15 can extend almost to the top edge of the side windows 2.

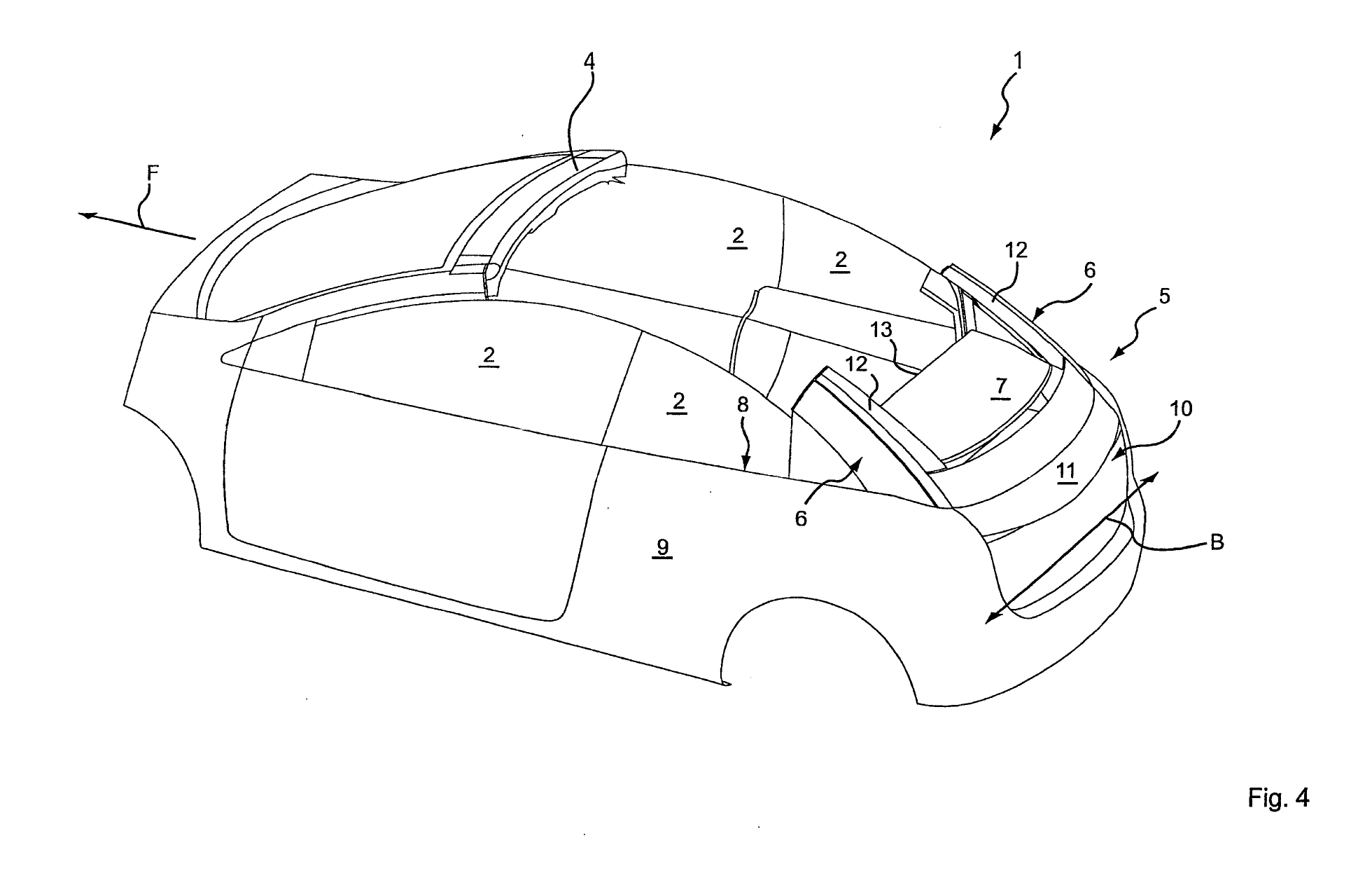

In each case the frame parts 3 can be removed after lowering the roof part 14, 15. Only the rear frame 6 remains and holds the movable rear hatch 10 between them (FIG. 4). In vehicles without these rear frames, the frame parts 3 after disassembly would completely expose the area above the window parapet line 8.

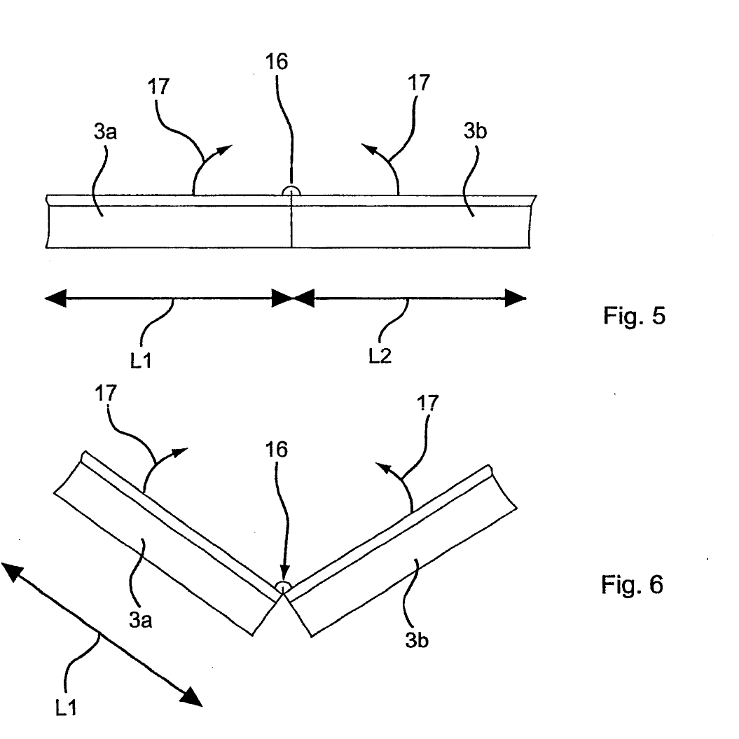

The frame parts 3 are divided here into a front section 3a and a rear section 3b. According to FIG. 5 and FIG. 6 the sections 3a, 3b can be pivoted relative to each other around the connecting hinge 16 in the direction of arrow 17. Instead of this, complete division of sections 3a, 3b is also possible. In both cases a rapid closure can be provided so that the sections 3a, 3b can be snapped against each other and therefore aligned with each other. Incorrect operation during installation is therefore ruled out. The sections 3a, 3b pivoted relative to each other or separated from each other are shorter in their maximum length L1, L2 than the vehicle width B, advantageously also shorter than the storage space width of the trunk. They can therefore be carried along during travel in the separated or pivoted-in state of sections 3a, 3b in vehicle 1, especially stowed hidden in the trunk.

The invention is applicable both in vehicles with roof parts 7, 14, 15 to be moved manually and with fully or partially automatic mobility of the parts. The roof can also be completely or partially flexible between the frame parts 3 and include, for example, a slatted roof part to be shortened or a roof part in the fashion of a roller shutter.

1. Motor vehicle (1) with at least one movable roof part (14; 15), which extends in the closed position at least partially between lateral frame parts (3) positioned above side windows of the vehicle and can be displaced from this position into an open position held in the auto body (9), in which the frame parts (3) can be disassembled in the open position of the roof part or parts (14; 15), characterized by the fact that each frame part (3) includes at least one hinge (16), around which individual sections (3a; 3b) of frame part (3) can be folded (17) against each other.

2. Motor vehicle (1) with at least one movable roof part (14; 15), which extends in the closed position between lateral frame parts (3) positioned at least partially above the side windows and can be displaced from this position into an open position held in the auto body (9), in which the frame parts (3) can be disassembled in the open position of the roof part or parts (14; 15), characterized by the fact that each frame part (3) can be divided into individual sections (3a; 3b) that are fully separable from each other.

3. Motor vehicle (1) according to claim 1, characterized by the fact that longitudinal extent (L1; L2) of the corresponding sections (3a; 3b) is smaller than the vehicle width (B).

4. Motor vehicle (1) according to claim 1, characterized by the fact that sections (3a; 3b) of the frame parts (3) can be secured to each other via a rapid closure.

5. Motor vehicle (1) according to claim 14, characterized by the fact that the roof part or parts (14; 15) are designed rigid.

6. Motor vehicle (1) according to claim 1, characterized by the fact that frame parts (3) are formed from lightweight material, especially a metal foam material.

7. Motor vehicle (1) according to claim 1, characterized by the fact that the removable frame parts (3) are located before, in the travel direction (F), in side rear frames (6) between which at least one rear window (7) is accommodated.

8. Motor vehicle (1) according to claim 7, characterized by the fact that the rear window (7) is movable and can be lowered into the body (9) for its opening.

9. Motor vehicle (1) according to claim 2, characterized by the fact that longitudinal extent (L1; L2) of the corresponding sections (3a; 3b) is smaller than the vehicle width (B).

10. Motor vehicle (1) according to claim 2, characterized by the fact that sections (3a; 3b) of the frame parts (3) can be secured to each other via a rapid closure.

11. Motor vehicle (1) according to claim 2, characterized by the fact that the roof part or parts (14; 15) are designed rigid.

12. Motor vehicle (1) according to claim 2, characterized by the fact that frame parts (3) are formed from lightweight material especially a metal foam material.

13. Motor vehicle (1) according to claim 2, characterized by the fact that the removable frame parts (3) are located before in the travel direction (F), in side rear frames (6) between which at least one rear window (7) is accommodated.

14. Motor vehicle (1) according to claim 13, characterized by the fact that the rear window (7) is movable and can be lowered into the body (9) for its opening.
